(19) United States
(12) Patent Application Publication
(10) Pub. No.: US 2010/0035206 A1
(43) Pub. Date: Feb. 11, 2010

(54) Dental tool for the fitting, installation and replacement of a dental prosthetic attachment

(76) Inventor: Joseph P. Buttacavoli, Brick, NJ (US)

Correspondence Address: CLIFFORD G. FRAYNE, Suite 7A, 136 Drum Point Road, Brick, NJ, 08723, US

(21) Appl. No.: 12/218,669

(22) Filed: Jul. 18, 2008

Related U.S. Application Data
(60) Provisional application No. 60/964,947, filed on Aug. 17, 2007.

(51) Int. Cl. A61C 3/00

(52) U.S. Cl. 433/146

(57) ABSTRACT

A dental tool having a handle and a tapered engagement end, the tapered engagement end ending in a blunt top of circular cross section, the blunt tip frictionally, mechanically engageable with the remains of a cored out temporary fabrication guide utilized in fitting a dental prosthetic anchor or attachment in the overall fitting of a denture to implant screws and for the replacement of permanent guides or permanent attachments for dental prosthesis when they become worn.

### RELATED APPLICATIONS

Applicant claims the benefit of provisional application Ser. No. 60/964,947, filed Aug. 17, 2007.

### BACKGROUND OF THE INVENTION

1. Field of the Invention

The present invention relates to dental prosthetics, and in particular, dental implants, and a specialized dental tool which assists in the fitting and installation of dental attachments.

2. Description of the Prior Art

Odontological prosthetics has made significant advancements from the removable denture to the anchored prosthesis to dental implant. Dental implants can be utilized to replace a lost tooth, a series of adjacent teeth which have been lost, or the entire upper and lower sets of teeth.

The process entails implanting a screw made of titanium or titanium alloy in a hole drilled in the alveolar bone so that the head of the screw is level with or just below the surface of the alveolar bone. The screw is then covered with mucus membrane and left to rest for a period in order to allow bone growth around the screw so as to firmly bond with the implanted screw. After sufficient time, the screw is exposed and a spacer is arranged thereon, after which the prosthesis is anchored to the spacer.

It will be recognized by those with ordinary skill in the art that a great degree of accuracy is required of the implant dentist when boring and setting the screw in the alveolar bone so as to insure that the implant and prosthetic tooth are in correct alignment with the remaining teeth for not only a proper bite, but also aesthetics. The need for accuracy is further compounded when a complete lower jaw or upper jaw implant is being fit in that such a prosthesis would normally require a minimum of four to six screw settings in the respective alveolar bone in order to support and secure a full prosthesis or denture.

In fitting the denture to the implant screws, care must be taken with respect to the alignment of the denture. In that regard, several temporary guide members or attachments are utilized with respect to the implant screws in aligning and identifying the points for connection on the denture. These temporary guides insure the proper fitting, and are disposed of once the alignment of the denture with the implant screws has been achieved and replaced with permanent attachments. Instructions which accompany the implant system kits direct that the removal of such temporary guides can be achieved with a normal dental pick. However, experience has shown that a normal dental pick is not advantageous for such removal in that it oftentimes will break off. There therefore has been a need for a specialized implement to be utilized in the removal of certain disposable guides utilized in the fitting of a prosthetic attachment.

Applicant's invention is directed to a tool which is not associated with the surgical procedure of setting the screws in the alveolar bone, but rather is associated with the fitting and setting of the prosthetic to the implant screws and anchors or attachments. Applicant's dental tool allows for the facile removal of certain temporary fabrication elements from the prosthesis which fabrication elements are expendable and disposed of, but nevertheless are necessary to achieve a proper fitting of the prosthesis to the implanted screws. The temporary fabrication elements or guides are replaced by permanent guides or fabrication elements which have a dental life expectancy of 3-5 years. These permanent guides or fabrication elements can also be facilely removed and replaced at the end of their life span by the dental implement and method described herein.

### OBJECTS OF THE INVENTION

An object of the present invention is to provide for a novel dental tool which facilitates the fitting and installation and replacement of a dental prosthetic anchor or attachment.

A still further object of the present invention is to provide for a novel dental tool which facilitates the removal of a male guide utilized in the set up and positioning of a denture to the implant screws.

### SUMMARY OF THE INVENTION

A dental tool having a handle and a tapered engagement end, the tapered engagement end ending in a blunt top of circular cross section, the blunt tip frictionally, mechanically engageable with the remains of a cored out temporary fabrication guide utilized in fitting a dental prosthetic anchor or attachment in the overall fitting of a denture to implant screws and for the replacement of permanent guides or permanent attachments for dental prosthesis when they become worn.

### BRIEF DESCRIPTION OF THE DRAWINGS

These and other objects of the present invention will become apparent, particularly when taken in light of the following illustrations wherein:

FIG. 1 is a perspective view of a plurality of implant screws with a male guide secured thereto;

FIG. 2 is a perspective view of the underside of the denture illustrating the removal of the male guide after fitting;

FIG. 3 is a side view of one embodiment of the dental tool; and

FIG. 4 is a side view of a second embodiment of the dental tool;

### DETAILED DESCRIPTION OF THE INVENTION

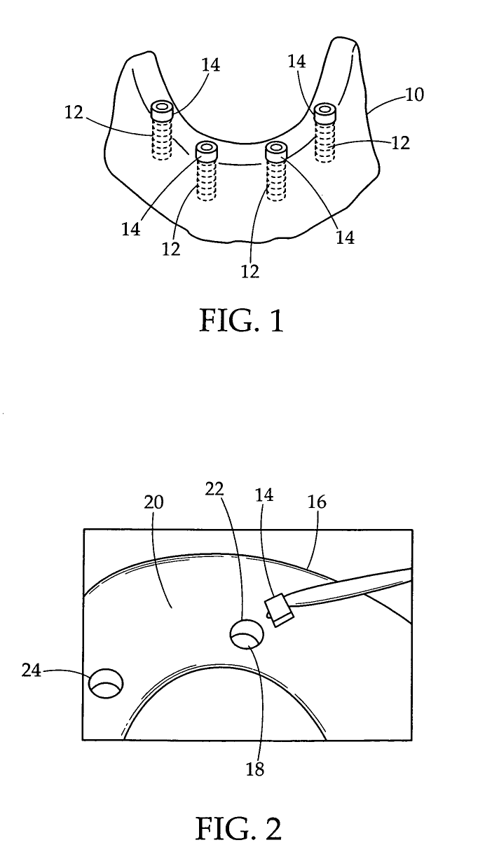

FIG. 1 is a perspective view of a mock up of the alveolar bone 10 in which a plurality of implants 12 have been imbedded, and FIG. 2 is an underside view of the dental prosthetic or denture 16. The imbedding of the implants is accomplished through surgical dental procedures well known in the art. In fitting the denture 16 to the implants, male fabrication guides 14 are snap fit to the implants.

The underside of the denture 16 is then prepared (See FIG. 2) using a rounded drill bur to prepare recesses 18 on the underside 20 of denture 16. In fitting the denture 16 to the implants 12 the temporary male fabrication guides 14 are transferred to the recesses 18 formed in the underside 20 of the denture 16, along with a metal jacket housing 22. To finalize the denture 16, the temporary male fabrication guides 14 must be removed and replaced with a permanent guide in the recesses 18 formed on the underside of the denture 16.

The procedure recommended for removing the initial male fabrication guides 14 from the recesses 18 on the underside of the denture 16 calls for a dental hand piece utilizing a core cutter at medium speed to cut out the center portion of the male fabrication guide 14. After the core has been removed, the procedure recommends collapsing the remaining ring of the male fabrication guide 14 into the open space using a standard dental instrument such as a dental pick, and lifting out the remains of the male fabrication guide 14. This final step proves difficult in that a typical dental pick will oftentimes break during the procedure. There is no danger to the patient since this step of the procedure is performed with the denture 16 outside of the patient's oral cavity, however, the dental pick itself is ruined for any future use and must be replaced by the dentist or dental technician.

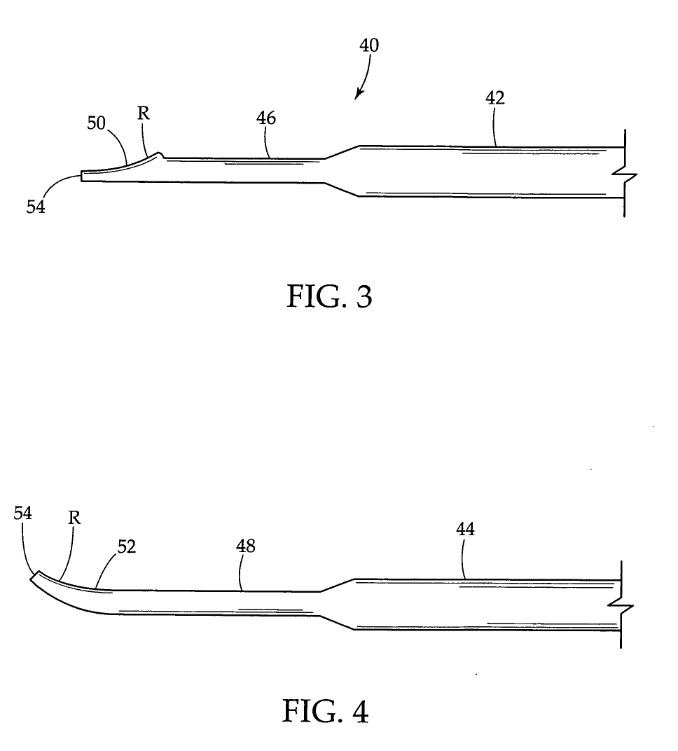

FIGS. 3 and 4 are side views illustrative of two embodiments which have been developed by Applicant, which perform the aforesaid procedural step of removing the remains of the male fabrication guide 14 from the recesses 18 on the underside of the denture 16. Both embodiments of the dental implement 40 as illustrated in FIGS. 3 and 4 would have a handle end 42 and 44 which would taper to an intermediate portion 46 and 48 which in turn would further taper to a blunt end 50 and 52 of circular cross section 54.

Dental implement 40 would be utilized after the core of the male fabrication guide 14 had been removed by a drill. Implant systems are often sold in kit form for each individual undergoing the procedure. There normally is an implant surgical kit which includes all of the necessary implant elements in order to properly, surgically place the implants in the alveolar bone. A second kit includes all of the dental implements required to fit and secure the dental prosthetic to the implants. Depending upon each manufacturers kit, the dimensions of the metal housings and fabrication males may vary slightly. Applicant has found that the dental implements as illustrated in FIGS. 3 and 4 are effective in removing the remainder of the male fabrication guide 14 after its center portion has been cored. To that end, the dental implement 40 illustrated in FIG. 3 has an operative blunt end 50 of a length of 0.125 inches and is formed with a tapered or curved side having a radius “R” of ⅜ths of an inch. The diameter of the blunt tip 54 in the design illustrated in FIG. 3 is 0.010 inches. With this design, the dentist inserts the blunt tip 54 into the cored male fabrication guide 14 and removes same with a twisting, pulling action.

The dental implement 40 illustrated in FIG. 4 includes a blunt end 52 of a length of 0.125 inches. In this embodiment, the entire blunt end tip is curved on a ⅜ths inch radius “R” terminating with a blunt end tip 54 having a diameter of 0.019 inches. The utilization of the dental implement as illustrated in FIG. 4 is identical to the utilization of the embodiment illustrated in FIG. 3 in that the blunt end tip 54 is inserted into the cored male fabrication guide 14 and with a twisting, pulling action, the remainder of the male fabrication guide 14 is removed from the underside of the prosthetic denture.

The elimination of a pointed end as found on a typical dentist pick eliminates the possibility of breakage, since the blunt end tips provide for greater strength and fits snugly into the cored male fabrication guide 14 so as to allow the blunt end tips 54 to securely, frictionally engage the cored temporary male fabrication guide 14 and with the twisting, pulling action, pop the remainder of the temporary male fabrication guide from the underside of the dental prosthetic.

The temporary male fabrication guide is replaced by a permanent attachment or guide some times referred to as an “O” ring. These permanent attachments are not permanent in the sense that they do wear over time and require replacement. The life expectancy of the permanent attachments is anywhere from 3-5 years. The dental implement described also allows the dentist to easily remove and replace these permanent attachments in the dental operatory.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A dental implement in the form of a hand tool which aids in the fabrication and fitting of a dental prosthetic to implants embedded and fixed within the oral cavity of a patient, the dental implement aiding in the removal of temporary or permanent guide members or attachments cooperative between the implants and the underside of the dental prosthetic to fit the dental prosthetic, the dental implement comprising:
a longitudinal dental implement having a first handle end of uniform cross section dimensioned to be held with fingers of the dental technician's hand, the first handle end tapering to an intermediate portion, said intermediate portion further tapering to an operative end of said dental implement, said operative end terminating in a blunt end of circular cross section, said blunt end of said operative end of said dental implement engageable with a temporary male fabrication guide affixed to the underside of a dental prosthetic after said dental prosthetic has been temporarily fitted to an implant post, said core of said temporary male fabrication guide having been bored by a dentist's drill allowing insertion of said blunt end of said operative end of said dental implement into said core for the twisting removal of said temporary male fabrication guide.

2. The dental implement in accordance with claim 1 wherein said operative end of said dental implement extends a length of inches.

3. The dental implement in accordance with claim 1 wherein said blunt end having a circular cross section has a diameter in the range of from 0.010 inches to 0.019 inches.

4. The dental implement in accordance with claim 1 wherein said taper of said blunt end having a circular cross section is tapered based on a radius of ⅜ths of an inch.
